(19) United States
(12) Patent Application Publication
(10) Pub. No.: US 2023/0280070 A1
(43) Pub. Date: Sep. 7, 2023

(54) SYSTEMS AND METHODS FOR PRE-HEATING SWIMMING POOLS OR SPAS

(71) Applicant: ZODIAC POOL SYSTEMS LLC, Carlsbad, CA (US)

(72) Inventors: Hwa Leung Heng, Carlsbad, CA (US); Mark Bauckman, San Marcos, CA (US)

(21) Appl. No.: 18/097,957

(22) Filed: Jan. 17, 2023

Related U.S. Application Data
(60) Provisional application No. 63/300,883, filed on Jan. 19, 2022.

(51) Int. Cl. F24H 15/175; E04H 4/12; F24H 15/212; F24H 15/281; F24H 15/355; F24H 15/429

(52) U.S. Cl. CPC F24H 15/175; E04H 4/129; F24H 15/212; F24H 15/281; F24H 15/355; F24H 15/429

(57) ABSTRACT

A heating system for a pool or spa includes at least one heating device and a controller. The controller may control and/or operate the at least one heating device in a pre-heat mode or a usage mode. The pre-heat mode may heat water of the pool or spa to a pre-heat temperature based on a first input received by the controller. The usage mode may heat the water to a set temperature greater than the pre-heat temperature based on a second input received by the controller after the first input.

### REFERENCE TO RELATED APPLICATION

This application claims the benefit of U.S. Provisional Pat. Application No. 63/300,883, filed on Jan. 19, 2022, and entitled SYSTEMS AND METHODS FOR PRE-HEATING SWIMMING POOLS OR SPAS, the content of which is hereby incorporated by reference in its entirety.

### FIELD OF THE INVENTION

This application relates to water-containing vessels such as swimming pools and spas, and more particularly to systems and methods for controlling a water temperature of water in the swimming pools or spas.

### BACKGROUND

Users of pools, spas and other water-containing vessels may desire a water to be at a set temperature when they start using the pool or spa. However, because decisions to use such pools and spas are often made with little advance planning or on an impulse, traditional heating systems are either (i) unable to accommodate heating in such a short period of time or (ii) require the user to operate heating systems in a mode that is wasteful from both a cost and environmental perspective. In particular, traditional heaters are either “off” or “on” when the water is heated to and/or maintained at the desired water temperature. FIG. 4 illustrates a typical water temperature profile of water heated using traditional systems and methods, and in particular shows the relatively long heat up time needed to heat the water to the desired water temperature. From FIG. 4, it can be seen that a user making a spontaneous decision to use the pool will require the heating system to run at the set temperature for a long duration, which is both costly and wasteful, or the user will start using the pool before the water is at the set temperature.

### SUMMARY

Described herein systems and methods for controlling water temperatures in pools or spas.

According to some embodiments, a method of heating a pool or spa includes receiving a set temperature for water of the pool or spa, heating the water to a pre-heat temperature less than the set temperature and holding the water at the pre-heat temperature for a duration, and heating the water from the pre-heat temperature to the set temperature.

A method of heating a pool or spa may include receiving a set temperature for water of the pool or spa, operating a heating system in a pre-heat mode for heating the water to a pre-heat temperature that is lower than the set temperature, and operating the heating system in a usage mode for heating the water from the pre-heat temperature to the set temperature.

According to various embodiments, a method of heating a pool with a heating system includes heating the pool pursuant to a stepped water temperature profile based on a received input from a user.

According to certain embodiments, a method of heating a pool or spa includes receiving a set temperature for water of the pool or spa, operating a heating system in a pre-heat mode for heating the water to a pre-heat temperature, and operating the heating system in a usage mode for heating the water to the set temperature.

A heating system for a pool or spa may include at least one heating device and a controller. The controller may control and/or operate the at least one heating device in a pre-heat mode or a usage mode in which the pre-heat mode heats the water to a pre-heat temperature for a period of time and the usage mode heats the water to a set temperature greater than the pre-heat temperature after the period of time has lapsed.

According to some embodiments, a method of heating a pool or spa includes receiving a first input from a user, heating water of the pool or spa to a pre-heat temperature, receiving a second input from the user, and heating the water from the pre-heat temperature to a set temperature greater than the pre-heat temperature based on the second input.

A method of heating a pool or spa may include receiving a first input from a user, heating water of the pool or spa to a pre-heat temperature and holding the water at the pre-heat temperature and heating the water from the pre-heat temperature to a set temperature greater than the pre-heat temperature based on a reception of a second input after the first input.

According to various embodiments, a method of heating a pool or spa includes receiving a first input from a user, heating water of the pool or spa to a pre-heat temperature and holding the water at the pre-heat temperature, and generating an alert when the water reaches the pre-heat temperature, the alert including a query about whether to heat the water to a set temperature greater than the pre-heat temperature.

A method of heating a pool or spa may include receiving a first input for a pool or spa, operating a heating system in a pre-heat mode for heating the water to a pre-heat temperature based on the first input, and operating the heating system in a usage mode for heating the water to the set temperature based on a received second input after the first input.

According to certain embodiments, a heating system for a pool or spa includes at least one heating device and a controller. The controller may control and/or operate the at least one heating device in an pre-heat mode or a usage mode, the pre-heat mode for heating the water to a pre-heat temperature based on a first input received by the controller, and the usage mode for heating the water to a set temperature greater than the pre-heat temperature based on a second input received by the controller after the first input.

Various implementations described herein may include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification refers to the following appended figures, in which use of like reference numerals in different figures is intended to illustrate like or analogous components.

FIG. 1 illustrates a pool system according to embodiments.

FIG. 2 illustrates a process for controlling a water temperature of water of a pool or spa according to embodiments.

FIG. 3 illustrates a water temperature profile at various stages of the process illustrated in FIG. 2.

FIG. 4 illustrates a typical water temperature profile of water heated using traditional systems and methods.

### DETAILED DESCRIPTION

Described herein are systems and methods for controlling water temperatures in pools or spas using intermediate temperatures or set points of the water. In some embodiments, the systems and methods provided herein provide a stepped water temperature control for controlling the water in a pool or spa. Compared to traditional systems and methods, the systems and methods provided herein may allow for rapid and/or shorter durations for heating the water to a desired temperature while improving energy efficiency and operation of equipment heating the water. Various other benefits and advantages may be realized with the systems and methods described herein, and the aforementioned benefits and advantages should not be considered limiting.

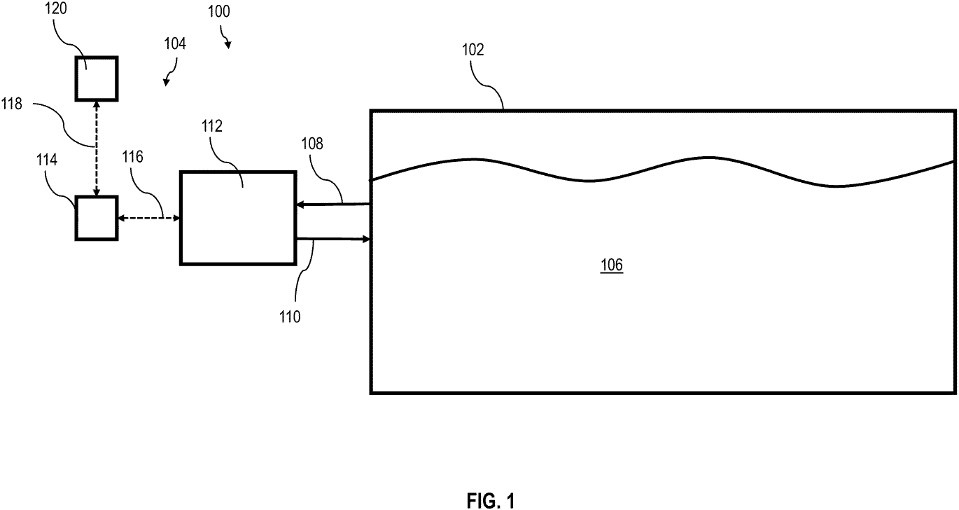

FIG. 1 illustrates an example of a pool system 100 with a pool 102 and a heating system 104 for heating water 106 for the pool 102. The heating system 104 may include one or more heating sources or devices 112 for heating water that is received from the pool 102 (represented by arrow 108) and returning the water to the pool 102 at a heated temperature (represented by arrow 110). The heating devices may be various types and/or combinations of heating devices as desired, including but not limited to heat pumps, electric heaters, gas heaters, and other suitable heading devices as desired.

In some embodiments, the heating system 104 includes a controller 114 (e.g., a processor and/or memory) that is communicatively coupled (represented by arrow 116) with the one or more heating devices 112. In some embodiments the controller 114 may be provided on the one or more heating devices 112, although in other embodiments, the controller 114 may be provided at various locations as desired, including remote from the heating device(s) 112. The controller 114 may control operation of the heating device(s) 112 as discussed in detail below. In certain embodiments, the controller 114 may control the heating device(s) 112 in at least two different modes - a pre-heat mode and a usage mode - to improve control of the water temperature of the pool.

In certain embodiments, the controller 114 may facilitate communication (e.g., sending and/or receiving information) with a user and/or remote communication device. As some examples, the controller 114 optionally may include a user interface (on the controller itself, on the heating device(s) 112, and/or as otherwise desired) for receiving various inputs from a user. Additionally or alternatively, the controller 114 may include one or more communication modules facilitating wired and/or wireless communication (e.g., cellular, Bluetooth, Wi-Fi, NFC, etc.) (represented by arrow 118 in FIG. 1) with a remote communication device 120 such as a user’s personal electronic device, laptop, phone, tablet, a remote controller device, and/or various other devices or plurality of devices as desired.

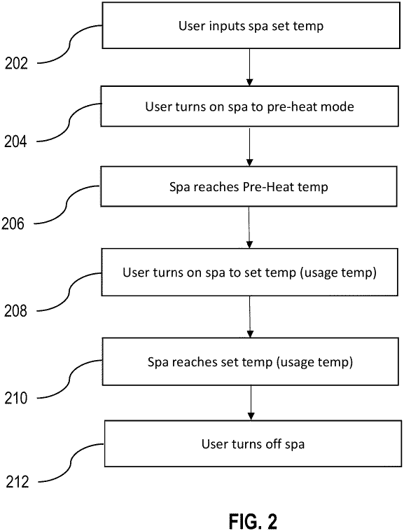

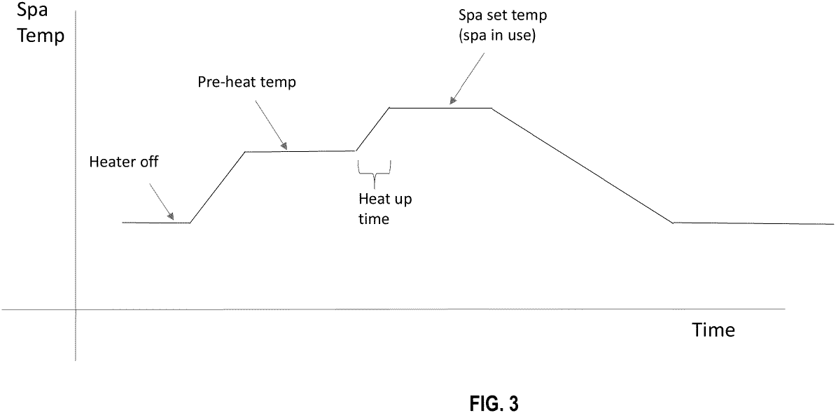

Referring to FIG. 2, a process for controlling a water temperature of the water 106 using the heating system 104 is described in detail. FIG. 3 illustrates a water temperature profile at various stages of the process illustrated in FIG. 2.

In a block 202, the process may include receiving an indication of future use of the pool or spa from the user. In some embodiments, block 202 may include receiving an initial activation of the heating system 104 by the user, optionally without any additional input such as a set temperature or a set time. Additionally, or alternatively, block 202 may include receiving at least a pool or spa set temperature. The set temperature may be a desired temperature that the user wants the water temperature to be at some time in the future.

The user may provide the initial activation and/or the set temperature to the heating system 104 via a user interface on the controller 114 and/or the heating device(s) 112. In other embodiments, the user may provide the initial activation and/or the set temperature to the heating system 104 while remote from a location of the pool 102. As a non-limiting example, the user may use her or his communication device 120 (e.g., phone, tablet, smart device, computer, etc.) to provide the heating system 104 with the initial activation and/or the set temperature by using an application on their phone and/or other wired or wireless communication techniques as desired. In some embodiments, the particular time may be known while in other embodiments the time at which the user desires the water temperature to be at the set temperature need not necessarily be known. As a non-limiting example, a user at 9:00 AM on a particular day may provide the heating system 104 with a set temperature of 85° F. without providing a particular time for the water to be at the set temperature. Additionally, or alternatively, block 202 may include receiving a set temperature and a desired time to heat up water from a pre-heat temperature to the set temperature. As a non-limiting example, block 202 may include receiving a set temperature of 85° F. and a desired pre-heat time of 15 minutes.

In a block 204, the process includes controlling the heating system 104 to be in the pre-heat mode. In certain embodiments, the user may provide an input (e.g., selection of a button, sending a signal, etc.) to control the heating system 104 to be in the pre-heat mode. In other embodiments, the controller 114 may automatically control the heating system 104 to be in the pre-heat mode based on input from the user in block 202 (e.g., the initial activation and/or the received set temperature, if provided). As a non-limiting example, the controller 114 may control the heating system 104 to be in the pre-heat mode based on the user providing a set temperature without a set time (e.g., a time at which the water is desired to be at the set temperature). As another non-limiting example, the controller 114 may control the heating system 104 to be in the pre-heat mode based on the user providing a set temperature and a set time that is greater than a predetermined duration in the future.

In these examples, the predetermined duration may be various calculated and/or provided durations as desired. As a non-limiting example, the predetermined duration may be an amount of time needed to continuously heat the water from a current water temperature to the set temperature. A non-limiting example of such a scenario may be the user provides a set time in block 202 that is four hours from the current time, and the controller 114 may automatically control the heating system 104 to be in the pre-heat mode based on the heat up time from the current water temperature to the set temperature being less than four hours. In other non-limiting examples, the controller 114 may control the heating system 104 to be in the pre-heat mode based on the user simply activating the heating system 104 in block 202.

In some non-limiting examples, the pre-heat temperature may be determined based on an estimate for the time to heat between the pre-heat and set temperatures. As a non-limiting example, the user input may be the set temperature and a desired time to heat up from the pre-heat to the set temperature. In such embodiments, the controller 114 may determine the pre-heat temperature based on at least the desired heat up time. Such a determination optionally may take into account additional input such as historical heating performance of a particular heating device, type of heating device, environmental conditions, etc. As a non-limiting example, the controller 114 may determine a pre-heat temperature to be 75° F. based on user input of a set temperature of 85° F. and a heating duration of 30 minutes based on heating performance of the heating system 104 and/or environmental conditions.

Controlling the heating system 104 to be in the pre-heat mode may include controlling the heating system 104 to heat the water to an intermediate (or pre-heat) temperature that is less than the set temperature and/or less than a temperature of the water when the heating system 104 is operating at full capacity. The intermediate temperature is also greater than the temperature of the water when the heating device(s) 112 are off and/or greater than a temperature of the water at the time the input is received in block 202. In some embodiments, the intermediate temperature may be provided by the user. However, in other embodiments, the controller 114 may determine the intermediate temperature. In such embodiments, the controller 114 may determine the intermediate temperature based on various factors or inputs as desired such as the desired set temperature, historical heating performance of the heating device(s) 112, actual heating performance of the heating device(s) 112, the type of heating device(s) 112, environmental conditions (e.g., air temperature, forecast weather, time of day, etc.), historical notice from the user (e.g., historically how long between receiving the set temperature does the user desire water to be at a set temperature), combinations thereof, and/or various other factors or combinations of factors as desired.

In a block 206, the process includes controlling the heating system 104 to heat the water to be at the intermediate temperature and maintaining the water temperature to be at the intermediate temperature. In certain embodiments, block 206 includes maintaining the water temperature to be at the intermediate temperature for a predetermined duration and/or until additional input is received from the user. While a single pre-heat temperature is illustrated (blocks 204 and 206) in FIG. 2, in other embodiments, the controller 114 may control the heating system 104 to heat the water to a plurality of intermediate temperatures.

Optionally, block 206 includes sending a notification, alert, and/or prompt to the user when the water temperature reaches the intermediate temperature. As a non-limiting example, the controller 114 may send and/or cause a notification to be sent to the user’s communication device 120 (e.g., via an application) notifying the user that the water is at the pre-heat temperature. The notification may also include generating a query about whether the user wants to operate in the usage mode to heat the water to the set temperature. In some embodiments, the alert may query or prompt the user about whether to heat the water to the set temperature. Optionally, the notification or alert to the user may enable reception of an input from the user to operate in the usage mode (discussed in detail below) and/or to deactivate the heating system 104.

In a block 208, the process includes controlling the heating system 104 to operate in the usage mode. In the usage mode, the heating system 104 is controlled to heat the water temperature from the intermediate temperature to the set temperature. In certain embodiments, block 208 includes receiving an input (e.g., activation or other indication) from the user via the user interface on the controller 114 and/or the heating device(s) 112 and/or receiving input via the communication device 120 (e.g., using an application). Optionally, block 208 includes receiving the input from the user via the notification provided to the user in block 206, although it need not in other embodiments.

In block 210, the process includes heating the water using the heating system 104 such that the water temperature reaches the set temperature. In some embodiments, block 210 may include maintaining the water temperature at the set temperature. In other embodiments, block 210 optionally includes controlling the heating system 104 to operate in a different heating mode (e.g., the pre-heat mode and/or deactivated) based on the water temperature being at the set temperature for a predetermined set temperature duration. In these embodiments, the predetermined set temperature duration may be provided by the user and/or determined by the controller 114 as desired.

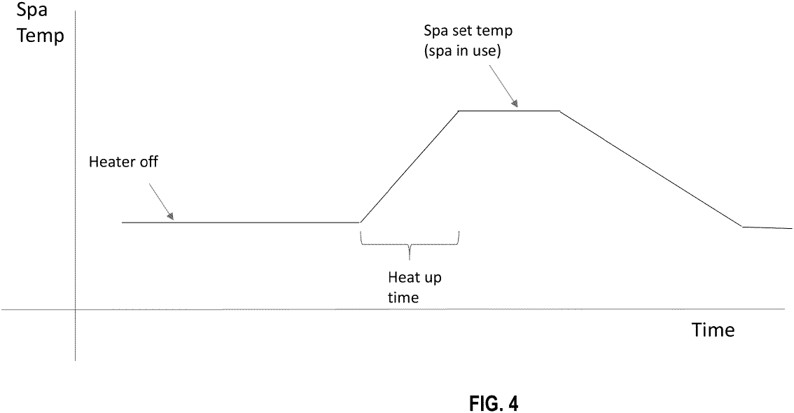

As illustrated by comparing FIG. 3 with FIG. 4, the heat up time according to the methods described herein is much shorter compared to traditional heat up times. The improved heat up time of the systems and embodiments disclosed herein may allow for an improved response to meet the user’s needs and may allow for the use of heating devices that might not otherwise be used. As an example, the systems and methods described herein may allow for the increased use of heat pumps as heating devices even though such devices might have a slower heating time compared to gas heaters, for example. The systems and methods described herein may also result in energy savings by having the pool or spa operate a pre-heat temperature that is lower than the set temperature over a period of time instead of having the pool or spa at the set temperature for the entire period of time.

In a block 212, the process includes deactivating the heating system 104. In certain embodiments, block 212 may be performed based on an input from the user (e.g., via the communication device 120). In other embodiments, the controller 114 may automatically deactivate the heating system 104. As a non-limiting example, the controller 114 may automatically deactivate the heating system 104 based on the heating system 104 being in the usage mode for a time exceeding the predetermined set temperature duration.

In other embodiments, the controller 114 may control the heating system 104 pursuant to other operating modes.

Exemplary concepts and combinations of features of the invention may include:

A. A method of heating a pool or spa, the method comprising receiving a set temperature for water of the pool or spa, heating the water to a pre-heat temperature less than the set temperature and holding the water at the pre-heat temperature for a duration, and heating the water from the pre-heat temperature to the set temperature.

B. The method according to statement A., wherein the duration is a predetermined duration.

C. The method according to statement A., wherein heating the water to the set temperature is based on an activation input.

D. The method according to any of statements A.-C., further comprising determining the pre-heat temperature based on the received set temperature.

E. The method according to any of statements A.-D., further comprising maintaining the water at the set temperature.

F. The method according to any of statements A.-E., further comprising generating an alert based on the water being heated to the pre-heat temperature.

G. The method according to any of statements A.-E., wherein the alert includes generating a query about whether to heat the water to the set temperature.

H. A method of heating a pool or spa, the method comprising receiving a set temperature for water of the pool or spa, operating a heating system in a pre-heat mode for heating the water to a pre-heat temperature that is lower than the set temperature, and operating the heating system in a usage mode for heating the water from the pre-heat temperature to the set temperature.

I. A method of heating a pool with a heating system pursuant to a stepped water temperature profile based on a received input from a user.

J. The method according to statement H., where the stepped water temperature profile is a two-step water temperature profile.

K. The method according to statement H. or I., wherein the received input is at least one of an initial activation of the heating system or a set temperature.

L. A method of heating a pool or spa, the method comprising receiving a set temperature for water of the pool or spa, operating a heating system in a pre-heat mode for heating the water to a pre-heat temperature, and operating the heating system in a usage mode for heating the water to the set temperature.

M. A heating system for a pool or spa, the heating system comprising at least one heating device and a controller, wherein the controller is configured to operate the at least one heating device in an pre-heat mode or a usage mode, the pre-heat mode for heating the water to a pre-heat temperature for a period of time, and the usage mode for heating the water to a set temperature greater than the pre-heat temperature after the period of time has lapsed.

N. A method of heating a pool or spa, the method comprising receiving a first input from a user, heating water of the pool or spa to a pre-heat temperature, receiving a second input from the user, and heating the water from the pre-heat temperature to a set temperature greater than the pre-heat temperature based on the second input.

O. The method according to statement M., wherein the first input is an initial activation of the heating system or the set temperature.

P. A method of heating a pool or spa, the method comprising receiving a first input from a user, heating water of the pool or spa to a pre-heat temperature and holding the water at the pre-heat temperature, and heating the water from the pre-heat temperature to a set temperature greater than the pre-heat temperature based on a reception of a second input after the first input.

Q. A method of heating a pool or spa, the method comprising receiving a first input from a user, heating water of the pool or spa to a pre-heat temperature and holding the water at the pre-heat temperature, and generating an alert when the water reaches the pre-heat temperature, the alert including a query about whether to heat the water to a set temperature greater than the pre-heat temperature.

R. A method of heating a pool or spa, the method comprising receiving a first input for a pool or spa, operating a heating system in a pre-heat mode for heating the water to a pre-heat temperature based on the first input, and operating the heating system in a usage mode for heating the water to the set temperature based on a received second input after the first input.

S. A heating system for a pool or spa, the heating system comprising at least one heating device and a controller, wherein the controller is configured to operate the at least one heating device in an pre-heat mode or a usage mode, the pre-heat mode for heating the water to a pre-heat temperature based on a first input received by the controller, and the usage mode for heating the water to a set temperature greater than the pre-heat temperature based on a second input received by the controller after the first input.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention.

The foregoing is provided for purposes of illustrating, explaining, and describing embodiments of the present invention. Modifications and adaptations to these embodiments will be apparent to those skilled in the art and may be made without departing from the scope of the invention. Additionally, the word “pool” and phrase “swimming pool” as used herein may also refer to spas or other water containing vessels or structures used for recreation or therapy, including both artificial and natural vessels, structures, and the like.

That which is claimed:

1. A method of heating a pool or spa, the method comprising receiving a set temperature for water of the pool or spa, heating the water to a pre-heat temperature less than the set temperature and holding the water at the pre-heat temperature for a duration, and heating the water from the pre-heat temperature to the set temperature.

2. The method of claim 1, wherein the duration is a predetermined duration.

3. The method of claim 1, wherein heating the water to the set temperature is based on an activation input.

4. The method of claim 1, further comprising determining the pre-heat temperature based on the received set temperature.

5. The method of claim 1, further comprising maintaining the water at the set temperature.

6. The method of claim 1, further comprising generating an alert based on the water being heated to the pre-heat temperature.

7. The method of claim 6, wherein the alert includes generating a query about whether to heat the water to the set temperature.

8. The method of claim 1, wherein heating the water to the set temperature is based on additional input, and wherein the additional input comprises at least one of historical heating performance of a heating source, actual heating performance of the heating source, a type of heating source, environmental conditions, or historical notice from a user.

9. A method of heating a pool with a heating system pursuant to a stepped water temperature profile based on a received input from a user.

10. The method of claim 9, where the stepped water temperature profile is a two-step water temperature profile.

11. The method of claim 9, wherein the received input is at least one of an initial activation of the heating system or a set temperature.

12. The method of claim 9, wherein heating the pool comprises operating the heating system in a pre-heat mode for heating the water to a pre-heat temperature and operating the heating system in a usage mode for heating the water to a set temperature, wherein the set temperature is greater than the pre-heat temperature.

13. The method of claim 12, further comprising holding the water at the pre-heat temperature for a period of time before operating the heating system in the usage mode.

14. The method of claim 9, wherein heating the pool is further based on additional input, and wherein the additional input comprises at least one of historical heating performance of a heating source, actual heating performance of the heating source, a type of heating source, environmental conditions, or historical notice from the user.

15. A method of heating a pool or spa, the method comprising receiving a first input and a second input for a pool or spa, operating a heating system in a pre-heat mode for heating water of the pool or spa to a pre-heat temperature based on the first input, and operating the heating system in a usage mode for heating the water to a set temperature based on the received second input after the pre-heat mode.

16. The method of claim 15, wherein the first input comprises at least one of a set temperature or a set time.

17. The method of claim 15, wherein the first input comprises a set temperature without a set time.

18. The method of claim 15, further comprising controlling the heating system to operate in the pre-heat mode or in a deactivated mode based on the water being at the set temperature for a predetermined set temperature duration.

19. The method of claim 15, wherein the second input is received after the first input.

20. The method of claim 15, further comprising determining the pre-heat temperature based on additional input, and wherein the additional input comprises at least one of historical heating performance of a heating source, actual heating performance of the heating source, a type of heating source, environmental conditions, or historical notice from a user.
